(19) United States
(12) Patent Application Publication
(10) Pub. No.: US 2016/0342546 A1
(43) Pub. Date: Nov. 24, 2016

(54) Paralleling Interface for power supply

(71) Applicant: Pacific Power Source, Inc., Irvine, CA (US)

(72) Inventor: Maximiliano O. Sonnaillon, Santa Fe (AR)

(21) Appl. No.: 14/999,525

(22) Filed: May 19, 2016

Related U.S. Application Data
(60) Provisional application No. 62/179,903, filed on May 21, 2015.

(51) Int. Cl. G06F 13/362; G06F 13/42; G06F 13/40; H02J 3/00

(52) U.S. Cl. CPC G06F 13/362; H02J 3/005; G06F 13/4282; G06F 13/4004

(57) ABSTRACT

An interface to connect in parallel two or more digitally controlled AC power supplies. The paralleling interface is based on a master-slave scheme, and includes up to 10 electrical signals. Each signal contributes to achieve transparent operation of the paralleled units, making it perform as if it was a single unit with increased power/current capability.

### RELATED APPLICATIONS

This application claims priority under 35 U.S.C. §119 to U.S. Provisional Application No. 62/179,903 filed on May 21, 2015, the contents of which are incorporated herein by reference in their entirety.

### FIELD OF THE INVENTION

This invention generally relates to parallel interfacing of digitally controlled power supplies.

### BACKGROUND OF THE INVENTION

In order to allow proper operation of parallel connected power supplies there may be additional circuits required that depend on the type of supply. For example, DC (direct current) current sources can be connected in parallel without any additional circuit or control loop. On the other hand, voltage sources require additional components or control loops to allow proper operation, such as a series diode to prevent circulating currents between DC supplies, often referred as OR-ing diodes. This prevents current circulation from one source to the other, but does not balance the output power of each source and it is not applicable to AC supplies. Having one source providing significantly more power than the other ones presents significant disadvantages, such as lower reliability and consistency in the output response. In order to provide balancing of the output power and prevent current circulation from one supply to the other, different circuits and techniques are used in the prior art. Adding a virtual output impedance by using output current feedback is a conventional technique that provides a simple solution when load regulation and/or output accuracy are not critical parameters. For high performance applications there are topologies used to control the output current of each voltage source and make it similar (or identical) between each other. The most important topologies are master/slave as in FIG. 1 and democratic sharing as in FIG. 2.

In the master/slave topology of FIG. 1, there is one unit referred as master (10), and one or more non-master units referred as slaves (13, 15). The output terminals of all units (12, 14, 16) are connected in parallel (17) to feed a load (18). The master unit sends a signal (11) to the slaves with a setpoint used by their internal control loops. The most common topology uses a unique outer voltage loop in the master unit, and individual inner current loops in all converters (including the master). The voltage loop generates a current setpoint that is sent to all units, thus providing balanced current across all converters. In a variation of this topology, the voltage loop can be implemented in a separate device that does not have a power converter and acts solely as the master controller. The master/slave approach is used in different implementation levels and applications, from high-end instrumentation equipment down to low-cost controller ICs.

An alternative approach is the one referred as democratic sharing, as illustrated in FIG. 2, which is does not rely on a single controller to provide current sharing. It employs a common bidirectional sharing bus (21) that all controllers (20, 23, 25) use to regulate their output current (22, 24, 26) in a parallel connection (27) to a load (28). In a conventional implementation, the sharing bus (21) represents the average output current of all converters, and they all individually use it as a feedback of a current sharing loop. This topology can impact output performance, for example output impedance or transient response.

One aspect of the present invention is based on a digital master/slave approach, combined with a bidirectional analog bus to provide total output current measurement to the master controller. The resulting paralleling interface provides benefits, such as a more optimum output performance and a number of features provided by digital technology.

### SUMMARY OF THE INVENTION

An electronic mixed-signal interface that connects two or more three phase AC power supplies in parallel with one of them acting as a master and one or more acting as slaves is an embodiment of the invention. There are three digital serial buses, one per phase, used by a master unit to send real-time data from a control loop to a plurality of slave units. There are also three analog signal buses where all units add a small-signal current proportional to their output current, used by all real-time control loops as feedback, feedforward and/or monitoring. A digital serial communication interface is used for non-real-time data transmission such as configuration or monitoring, and the master generating one optional synchronization signal that is used by a plurality of nodes to synchronize digital control sampling time and/or power stage switching. In this embodiment, any node is capable of generating an optional global fault logic signal in case of a fault in the power stage, and which causes an immediate shut down of all other power stages. All units sharing an optional daisy chain signal automatically detect the position in the system, enable bus termination resistors, and determine which unit is the default master.

### BRIEF DESCRIPTION OF THE DRAWINGS

The invention is generally shown by way of reference to the accompanying drawings in which:

FIG. 1 is a block diagram of prior art, conventional master/slave topology;

FIG. 2 is a block diagram of prior art, democratic sharing topology;

FIG. 3 is a block circuit diagram of two three-phase units connected in parallel with the preferred embodiment of this invention:

FIG. 4 is a block diagram of how the daisy-chain scheme of this invention operates when three units are connected in parallel;

FIG. 5 is a circuit block diagram identifying a four level generation and detection;

FIG. 6 is a table of four possible values of the daisy chain signals; and

FIG. 7 is a circuit block diagram to detect when a unit connected in the paralleling bus is not energized.

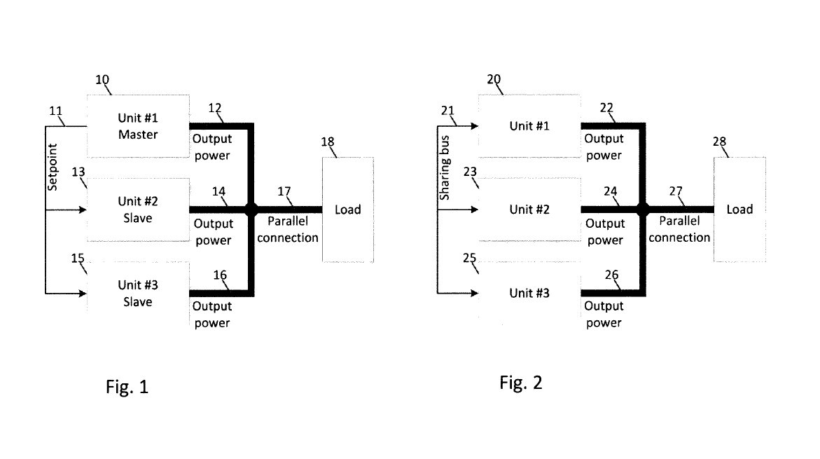

### DETAILED DESCRIPTION OF THE INVENTION

The paralleling interface of this invention is based on a master-slave scheme, and includes up to 10 electrical signals. Each signal contributes to achieve transparent operation of the paralleled units, making it perform as if it was a single unit with increased power/current capability. The signals that compose the interface are: 1) up to 3 unidirectional digital signals that send real-time data from the master unit to the slaves, 2) up to 3 analog signals with the measurement of the total output current generated at the output, 3) a multi-node digital bus used to transmit non-real-time information, 4) a unidirectional synchronization signal generated by the master, 5) a multi-node fault signal, and 6) a bidirectional daisy chain signal used to automatically detect units and organize the paralleling bus.

In a case of three phase AC sources, the signals related to the real-time control loop (items 1 and 2) are repeated three times (one per phase), thus making a total of ten signals. In a single-phase unit (i.e. single AC or DC output), the total number of signals is six. The paralleling interface of this invention also allows to operate one or more three-phase units in single phase mode, by internally connecting all power converters in parallel.

The preferred embodiment of this invention includes a circuit that implements an interface to connect two or more three-phase programmable AC power supplies in parallel. A system consist of one master unit that generates a set of signals, and one or more slave units that read these signals and can write on some of them. The signals that are generated only by the master are referred as unidirectional, and the ones that can be modified by any unit in the system are referred as bidirectional.

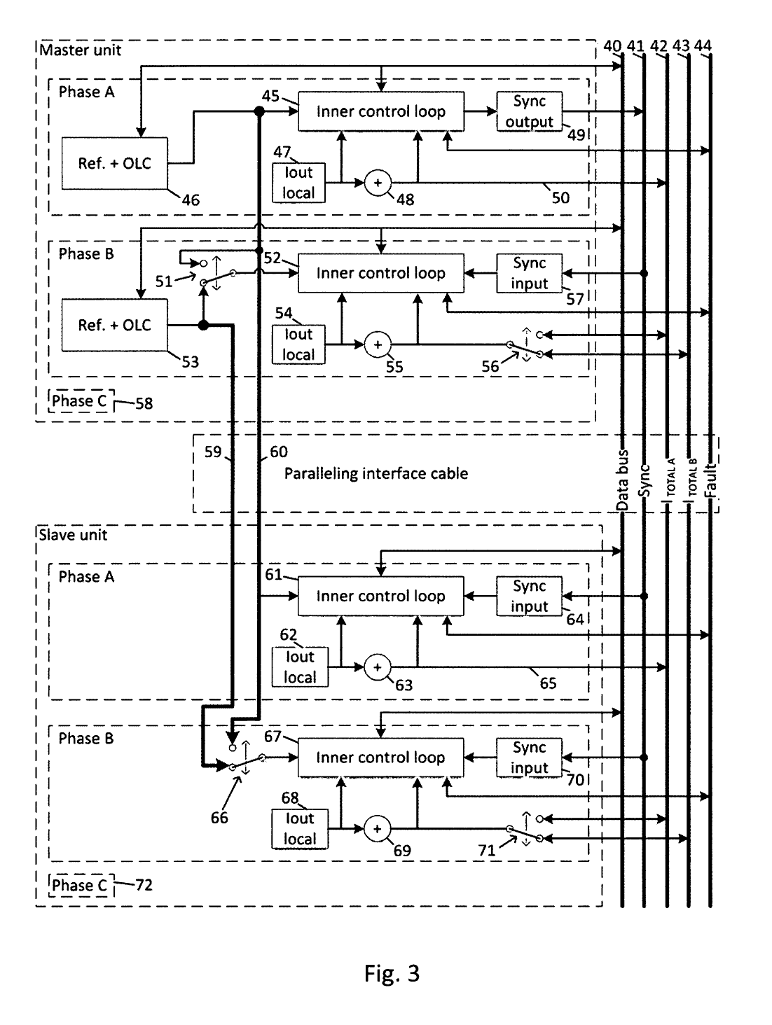

FIG. 3 shows a simplified block diagram of two units connected in parallel exemplifying the preferred embodiment of this invention. Each unit has three power converters inside, corresponding to each of the phases of a three-phase AC supply, which are controlled by separate digital circuits (e.g. three microprocessors or gate arrays). The top unit is acting as the master and the rest as slaves, but all units have the same hardware and their role in the system can be configured. In order to simplify the figure, phase C converter was not included in detail. In the preferred embodiment of this invention, phase C operates identically to phase B, having the same internal components and external interfaces.

Each converter in the master unit generates the reference signal and has an outer loop controller (OLC) that regulates output voltage (46, 53). Each OLC sends a setpoint to the local inner loop controller (ILC) (45, 52) and the ILCs of the paralleled units (61, 67) using a unidirectional serial bus (59, 60). The ILC in each phase regulates the current and/or voltage based on the received setpoint from the OLC, by utilizing pulse width modulation in the power stage. Each power converter measures its own output current, referred as Tout local (47, 54, 62, 68), and uses it as feedback of the ILCs. The ILCs may use other possible measurements as in conventional control of power converters. The ILC of each phase adds its lout local measurement to an analog bus by using an operational amplifier circuit configured as a conventional summing stage (48, 55, 63, 69). The result of the sum is the total current of all converters connected in parallel, and generates a bidirectional analog signal (50 and 65 for phase A, 56 and 71 for phase B) used in all converters of the same phase. The total current signal is also used by the ILC for current sharing purposes, to enhance transient response and/or also by the converters for metering and protection purposes.

In phase A of each unit, the total current bus (50, 65) is connected directly to the paralleling interface signal I_{TOTALA} (42). In phase B (and C), there are analog switches (56, 71) that allow to choose if the total current bus is connected to I_{TOTALB} (43) or to I_{TOTALA} (42). The purpose of combining the output current measurement of all phases into one signal (42) is to operate all converters in parallel for single-phase mode.

In single-phase mode, only the setpoint generated by phase A OLC is used by all phases. In phase B (and C) controller of each unit there is a digital switch (51, 66) that selects what setpoint the local ILC uses, whether the one coming from phase A master OLC or the one generated by phase B master OLC. In three-phase mode the digital switches (51, 66) connect all phase B ILCs to use the setpoint signal (59) generated by phase B master controller (53). In single-phase mode, all ILCs use the setpoint (60) generated by phase A master controller (46). In the preferred embodiment of this invention, digital switches (51, 66) and analog switches (56, 71) are operated together to change the system mode of operation between three-phase and single-phase.

The ILC is implemented by a digital controller, such as microprocessor or a gate array, and performs conventional digital control loop operations. The digital controller needs to sample the analog signals and process them to generate the required PWM in order to control the power stage. The sampling/processing time of the controller is synchronized by a unidirectional sync signal in the paralleling bus (41), generated by phase A controller of the master unit. The synchronization of the sampling time can be implemented with conventional digital techniques, such as interrupts or latches, and helps to eliminate delays and jitter caused when the different controllers are out of sync. The sync signal (41) can be also used to synchronize and interleave the power stages switching, thus minimizing ripple and noise in the system. Power stage switching synchronization can be implemented by digital or analog techniques that depend on the specific implementation, and can be found in the prior art.

The paralleling bus has a multi-node serial data interface that is used by all controllers in the system to send and receive non-real time data, such as configuration parameters or slow protection information.

When connected in parallel, a fault or failure in one power stage can cause damage in the other ones, and this is especially common in AC supplies because they can operate in the four V/I quadrants. In order to provide real-time protection, the paralleling bus has a global fault signal (44) that is immediately activated by any controller in case of fault. In the preferred embodiment of this invention, all controllers will instantly shut down when the global fault signal (44) is activated. Only when the fault is cleared the controllers are allowed to operate again.

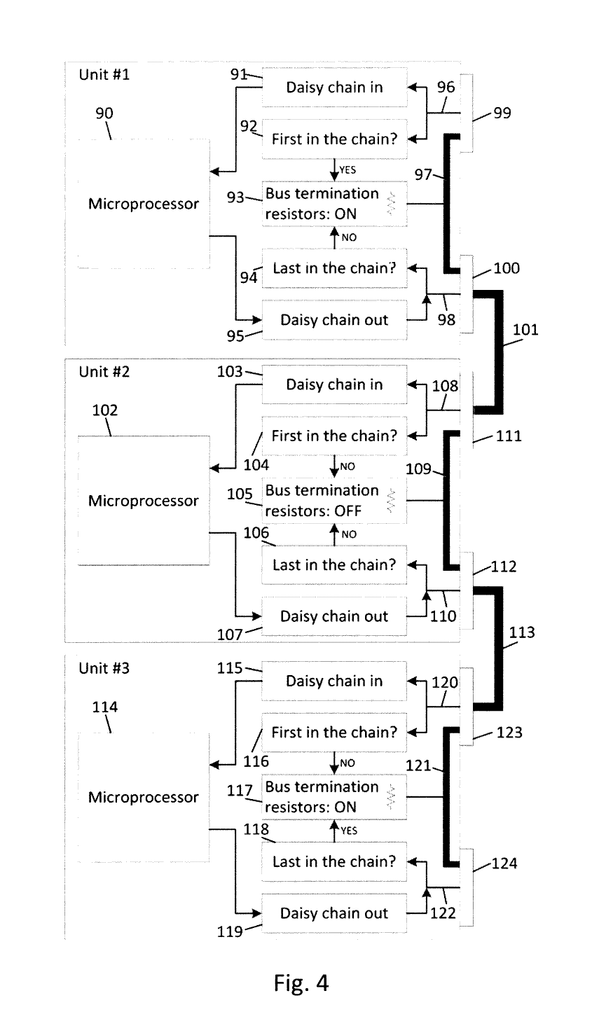

FIG. 4 describes how the daisy-chain of this invention operates when three units are connected in parallel. Each unit has two paralleling ports (99 and 100, 111 and 112, and 123 and 124), the top one referred as input and the bottom as output. The presented circuit makes use of these two connectors to interconnect two or more units in a daisy-chain fashion, also to identify the order of connection and to enable bus termination resistors required for high-speed digital buses.

In the preferred embodiment of this invention, the paralleling interface is composed by the nine signals described in FIG. 3, plus one more called daisy-chain signal. In FIG. 4, the daisy chain signal in the input port (96) is different than the signal in the output port (98), but all other nine signals are the same (97) and directly shared between all units. The daisy-chain in signal of one unit (108, 120) is connected to the daisy-chain out signal of the previous unit (110, 122). If there is no unit connected to the input port, then the daisy chain in signal will have no connection (96). If there is no unit connected to the output port, then the daisy chain out signal will have no connection (122).

In case of the first unit, a detection circuit (92) identifies that the daisy chain input signal has no connection and enables the bus termination resistors (93). In case of the last unit, a detection circuit (118) detects that the daisy chain output signal has no connection and enables the bus termination resistors (117). This provides bus termination resistors at both ends of the bus, without any microprocessor intervention.

The daisy-chain signal is also used to automatically detect all connected units, identify the connection order, and to assign an address to each controller as needed in multi-node bidirectional communications. The unit order identification is achieved by allowing each unit to send a digital data bit (i.e. 0 or 1) to the unit connected to its output port. This means that the data bit is sent from the output port of each unit to the input port of the next one. In the preferred embodiment of this invention, this data bit is sent by using four voltage levels in the same daisy-chain signal used for bus termination detection. In an alternative embodiment, 2 two-level independent signals could be used for the same purpose, one for unit identification and the other for bus termination detection.

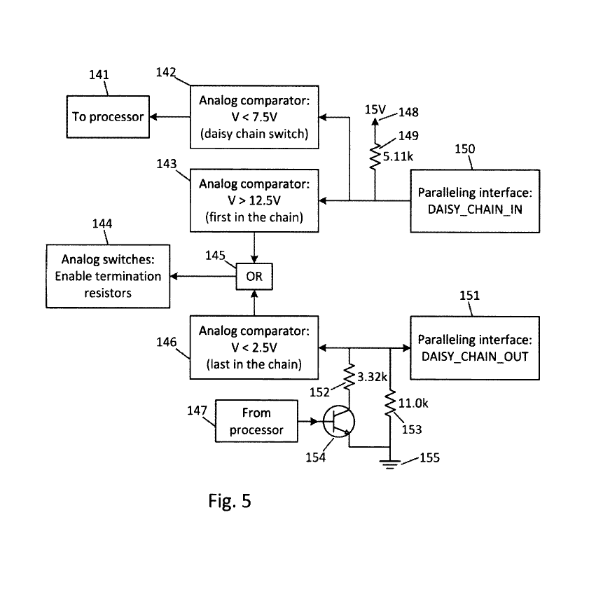

The four-level generation and detection is implemented with the circuit in FIG. 5. The daisy-chain signal can take one of four approximately equidistant values, such as 0V, 5V, 10V and 15V. Each value represents each of the four possible connection states. The data bit is defined by the state of a transistor (154).

The DAISY_CHAIN_IN signal has a pull-up resistor (149) to a 15V voltage supply (148). In case there is no other circuit connected to this signal (i.e. first unit in the chain), its voltage value will be equal to the supply voltage (15V). The DAISY_CHAIN_OUT signal has a resistor (153) connected to ground (155) and also a second resistor (152) conditionally connected to ground depending on the state of a transistor (154). This transistor (154) is controlled by the microprocessor. When there is no unit connected in the output port, then the DAISY_CHAIN_OUT signal has no other circuit connected to it and always has 0V.

When there are two or more units in parallel, the DAISY_CHAIN_OUT signal of the first unit is connected to the DAISY_CHAIN_IN signal of the following unit, thus creating a voltage divider. If the transistor (154) is off, then the two resistors (149 and 153) create an intermediate voltage, between 15V and 0V. When the transistor (154) is enabled, then this intermediate voltage is lower because a third resistor (152) is part of the voltage divider, reducing the equivalent resistance of the bottom part of the divider (152 and 153).

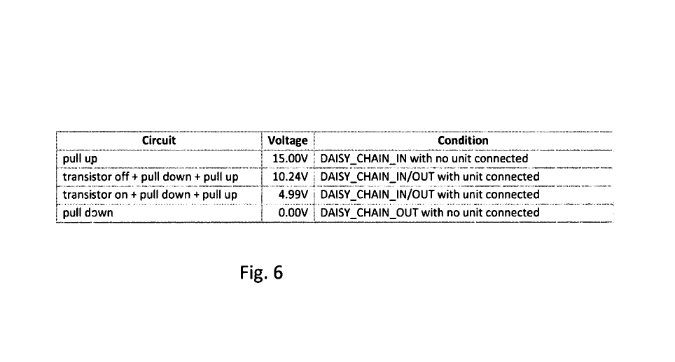

With the resistor values in the figure, the four possible values of the daisy chain signals are shown in FIG. 6. They are approximately equidistant and equal to 0, ⅓, ⅔ and 3/3 of the supply voltage. In FIG. 5, there are three analog comparators (142, 143, 146) used to identify the possible states and generate actions. Comparator (143) detects that there is no other unit connected to the input port and generates a digital signal to enable the termination resistors by means of analog switches (144). The comparator in (146) detects if the presence of a unit at the output port and generates a digital signal, which is also used to enable the termination resistors. There is one set of termination resistors required, so the outputs of both comparators (143 and 146) are ORed with a logic gate (145) to generate one resultant signal to enable the bus terminations.

When the processor changes the state of the transistor (154) and there is a unit connected to the output port, then the DAISY_CHAIN_OUT signal alternates between ⅓ and ⅔ the supply. This is detected in the next unit by using the analog comparator in (142), which generates a digital signal then used by the processor.

The purpose of the data bit is to enable an automatic sequence to be executed by the master unit processor, where it scans all nodes present in the system. At power-on all units start with their transistors (154) turned on, so all units will have a DAISY_CHAIN_{—} IN signal lower than 7.5V except from the first unit. The first unit detects that there is no other unit connected to its input port with comparator (142) and it automatically takes the role of master. After that, the master controller performs a sequential scan of the units connected to the paralleling interface. The scan makes use of both the bidirectional data bus to request information to the other units and the daisy-chain signal to detect connection order. The master first disables its transistor (154) and asks through the digital bus for the unit that is receiving the corresponding data bit value (i.e. V>7.5V) at DAISY_CHAIN_IN. The second unit will detect this condition with comparator (142) and respond to the master unit request. As soon as each unit is detected by the master, it turns off its transistor (154) to make possible the detection of the next one in the chain. This process is repeated until all units are detected by the master and have a bus node address assigned.

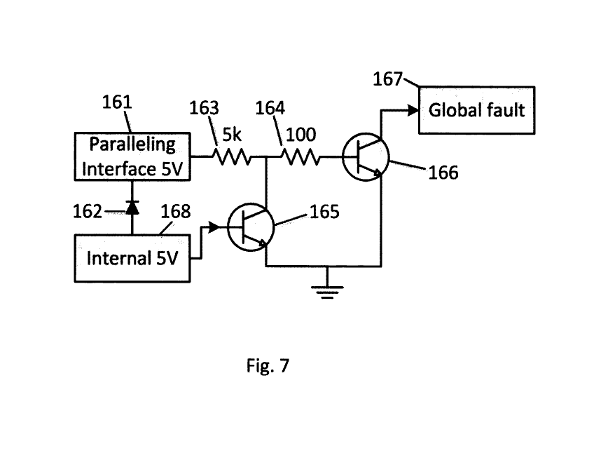

In the preferred embodiment of this invention, there is a circuit to detect when a unit connected in the paralleling bus is not energized as shown in FIG. 7. The internal bias supply voltage (168) of all units generate a common bias voltage in the paralleling interface by using diodes (162). The paralleling interface supply (PIS) feeds a transistor (166) through two resistors (163 and 164). When the transistor is enabled, the global fault signal is pulled down, thus generating a fault that is detected by all units. When the internal supply of the unit is energized, there is a transistor (165) that pulls down the drive of the previous transistor (166), thus avoiding the generation of the fault. If the internal supply is not energized, the PIS is provided by the supply of other units so transistor (166) is enabled. This circuit detects if any unit in the chain is not energized, which could otherwise create mal-operation with the analog and digital signals of the paralleling interface.

While embodiments have been described in detail, it should be appreciated that various modifications and/or variations may be made without departing from the scope or spirit of the invention. In this regard it is important to note that practicing the invention is not limited to the applications described herein. Many other applications and/or alterations may be utilized provided that such other applications and/or alterations do not depart from the intended purpose of the invention. Also, features illustrated or described as part of one embodiment may be used in another embodiment to provide yet another embodiment such that the features are not limited to the embodiments described herein. Thus, it is intended that the invention cover all such embodiments and variations. Nothing in this disclosure is intended to limit the scope of the invention in any way.

What is claimed is:

1. An electronic mixed-signal interface to connect two or more three phase AC power supplies in parallel with one of them acting as a master and one or more acting as slaves comprising:
a. three digital serial buses, one per phase, used by a master unit to send real-time data from a control loop to a plurality of slave units;
b. three analog signal buses where all units add a small-signal current proportional to their output current, used by all real-time control loops as feedback, feedforward and/or monitoring;
c. a digital serial communication interface, used for non-real-time data transmission such as configuration or monitoring;
d. the master generating one synchronization signal that is used by a plurality of nodes to synchronize digital control sampling time and/or power stage switching;
e. any node capable of generating a global fault logic signal in case of a fault in the power stage, and which causes an immediate shut down of all other power stages; and
f. all units sharing a daisy chain signal which automatically detects the position of the unit in the system, enables bus termination resistors, and determines which unit is the default master.

1. An electronic mixed-signal interface method comprising the steps of:
a. sending real-time data from a master unit through a control loop to a plurality of slave units through three digital serial buses;
b. adding a small-signal current that is proportional to the output current of the units and used by all real-time control loops as feedback, feedforward and/or monitoring;
c. transmitting non-real time data such as configuration or monitoring through a digital serial communication interface;
d. generating one synchronization signal by the master that is used by a plurality of nodes to synchronize digital control sampling time and/or power stage switching;
e. generating a global fault logic signal by a node in case of a fault in the power stage, and which causes an immediate shut down of all other power stages; and
f. sharing of a daisy chain signal all units which automatically detects the position of the unit in the system, enables bus termination resistors, and determines which unit is the default master.
